(19) United States
(12) Patent Application Publication
(10) Pub. No.: US 2024/0053756 A1
(43) Pub. Date: Feb. 15, 2024

(54) AUTONOMOUS MOBILE VEHICLE, AND GUIDANCE AND OBSTACLE AVOIDANCE METHOD FOR AN ENVIRONMENTAL FIELD

(71) Applicant: ADATA TECHNOLOGY CO., LTD., New Taipei City (TW)

(72) Inventor: Chia-Hsiang Hsiao, New Taipei City (TW)

(21) Appl. No.: 17/641,434

(22) PCT Filed: Feb. 11, 2022
(86) PCT No.: PCT/CN2022/075968

§ 371 Date: Mar. 9, 2022

Related U.S. Application Data
(60) Provisional application No. 63/284,651, filed on Dec. 1, 2021.

(51) Int. Cl. G05D 1/02

(52) U.S. Cl. CPC G05D 1/0214; G05D 1/0289; G05D 1/024; G05D 1/0274

(57) ABSTRACT

An autonomous mobile vehicle for loading and unloading goods in an environmental field, and a guidance and obstacle avoidance method are provided. The autonomous mobile vehicle includes a vehicle body, a first Lidar module, and a second Lidar module. The vehicle body is configured to carry goods, the first Lidar module is fixed on the vehicle body and the second Lidar module is selectively assembled on and disassembled from the vehicle body. When the second Lidar module is assembled on the vehicle body, the autonomous mobile vehicle uses the second Lidar module to establish a map of the environmental field. When the second Lidar module is disassembled from the vehicle body, the autonomous mobile vehicle is guided by using the first Lidar module according to the map, so as to perform an obstacle avoidance on a moving path of the autonomous mobile vehicle.

### FIELD

### Field of the Invention

The present invention relates to an autonomous mobile vehicle, and more particularly to an autonomous mobile vehicle for establishing a map and being guided for an obstacle avoidance.

### Background of the Invention

For the use of autonomous mobile vehicles, the cost of the highest proportion falls on the selection of Lidar. The high-resolution Lidar can easily establish a complete map in an unfamiliar field; however, the Lidar with a relatively low resolution often has too large errors in the creation of the map, which causes the label to be unable to be continuous and cause errors. And then the map cannot be established. Therefore, the cost of autonomous mobile vehicles is reduced, and at the same time, problems such as abnormal map creation or failure of map creation due to insufficient Lidar resolution will not occur, which is an important issue to be solved in the technical field.

### SUMMARY OF THE INVENTION

An autonomous mobile vehicle, and a guidance and obstacle avoidance method are provided. When the autonomous mobile vehicle first arrives in the environmental field, the autonomous mobile vehicle dispatching station assembles a high-resolution Lidar on the autonomous mobile vehicle, so that the autonomous mobile vehicle can easily create a map of the environmental field through the high-resolution Lidar and upload the map of the environmental field to a cloud server, and other autonomous mobile vehicles can download the map of the environmental field from the cloud server. After establishing the map of the environmental field, the autonomous mobile vehicle dispatching station disassembles the high-resolution Lidar from the autonomous mobile vehicle, and all the autonomous mobile vehicles can operate according to the complete map in the future, and can be guided based on the complete map and avoid obstacles through the low-resolution Lidar fixed on the autonomous mobile vehicle. In this way, the cost of autonomous mobile vehicles can be reduced, and at the same time, problems such as abnormal map creation or failure of map creation due to insufficient Lidar resolution will not occur.

An autonomous mobile vehicle provided by the present invention is applied to load and unload goods in an environmental field. The autonomous mobile vehicle includes a vehicle body, a first Lidar module, and a second Lidar module. The vehicle body is configured to carry goods. The first Lidar module is fixed on the vehicle body. The second Lidar module is selectively assembled on and disassembled from the vehicle body. When the second Lidar module is assembled on the vehicle body, the autonomous mobile vehicle uses the second Lidar module to establish a map of the environmental field. When the second Lidar module is disassembled from the vehicle body, the autonomous mobile vehicle is guided by using the first Lidar module according to the map to perform an obstacle avoidance on a moving path of the autonomous mobile vehicle.

A guidance and obstacle avoidance method for an environmental field provided by the present invention is applied to a plurality of autonomous mobile vehicles, wherein each of the plurality of autonomous mobile vehicles includes a vehicle body and a first Lidar module fixed on the vehicle body. The guidance and obstacle avoidance method includes: assembling a second Lidar module on the vehicle body of a first autonomous mobile vehicle; using the second Lidar module, by the first autonomous mobile vehicle, to establish a map of the environmental field; disassembling the second Lidar module from the vehicle body of the first autonomous mobile vehicle; uploading the map of the environmental field to a cloud server by the first autonomous mobile vehicle; downloading the map of the environmental field from the cloud server by other autonomous mobile vehicles and using the first Lidar module for guiding according to the map, by each of the plurality of autonomous mobile vehicles, to perform an obstacle avoidance on moving paths of the autonomous mobile vehicle.

In an embodiment of the present invention, the first Lidar module is a low-resolution Lidar module, and the second Lidar module is a high-resolution Lidar module.

In an embodiment of the present invention, the high-resolution Lidar module further includes a bracket for supporting and electrically connecting a high-resolution Lidar.

In an embodiment of the present invention, the bracket is connected to the vehicle body with contact electrical contacts to perform power and signal transmission.

In an embodiment of the present invention, the bracket is fixed on the vehicle body by a magnetic attraction.

In an embodiment of the present invention, the autonomous mobile vehicle includes an autonomous mobile robot (AMR) and an automated guided vehicle (AGV).

Due to the use of the detachable high-resolution Lidar module in the present invention, the autonomous mobile vehicle can be equipped with the high-resolution Lidar module to establish the map of the environmental field, and after the high-resolution Lidar module is disassembled, the autonomous mobile vehicle is guided based on the complete map and avoid obstacles through the low-resolution Lidar fixed on it, so the cost of autonomous mobile vehicles can be reduced, and at the same time, problems such as abnormal map creation or failure of map creation will not occur due to insufficient Lidar resolution.

In order to make the above and other objects, features, and advantages of the present invention more comprehensible, embodiments are described below in detail with reference to the accompanying drawings, as follows.

### BRIEF DESCRIPTION OF THE DRAWINGS

FIG. 1 is a schematic diagram of an autonomous mobile vehicle dispatching station provided by an embodiment of the present invention;

FIG. 2 is a schematic diagram of an autonomous mobile vehicle provided by an embodiment of the present invention; and

FIG. 3 is a flow diagram of a guidance and obstacle avoidance method for an environmental field provided by an embodiment of the present invention.

### DETAILED DESCRIPTION OF PREFERRED EMBODIMENTS

Hereinafter, the present invention will be described in detail with drawings illustrating various embodiments of the present invention. However, the concept of the present invention may be embodied in many different forms and should not be construed as limitative of the exemplary embodiments set forth herein. In addition, the same reference number in the figures can be used to represent the similar elements.

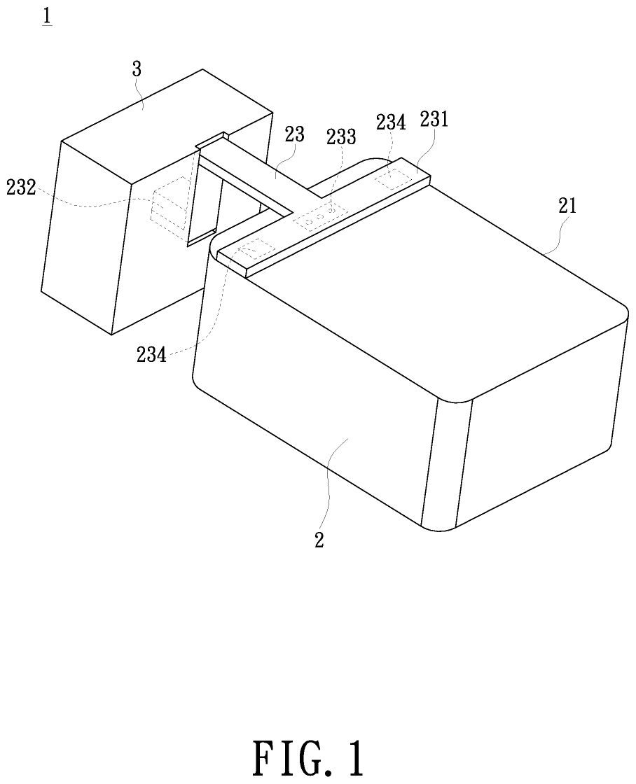

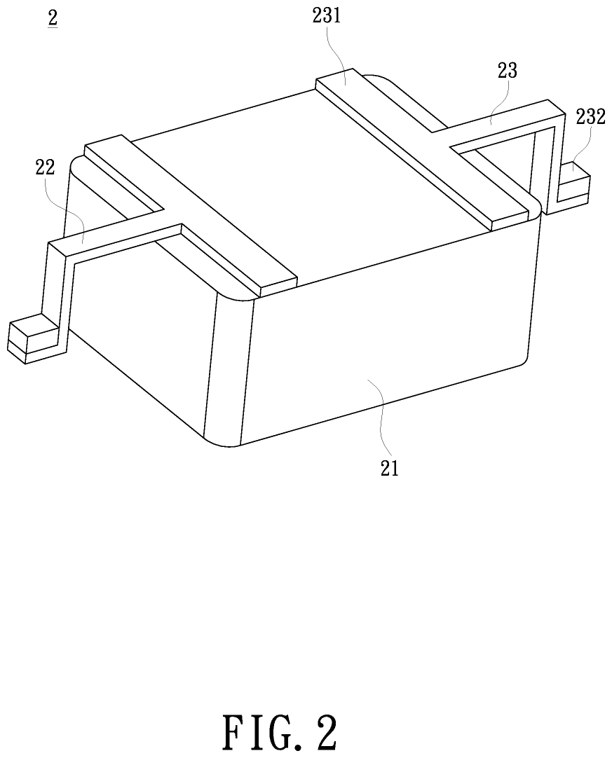

Please refer to FIGS. 1 and 2, the schematic diagrams of the autonomous mobile vehicle dispatching station and the autonomous mobile vehicle are provided by embodiments of the present invention. The autonomous mobile vehicle dispatching station 1 is applied to dispatch tasks to enable autonomous mobile vehicles to load and unload goods in an environmental field. The autonomous mobile vehicle dispatching station 1 includes at least one autonomous mobile vehicle 2, a Lidar module assembly and disassembly equipment 3, and a goods load and unload equipment (not shown). It should be noted that the autonomous mobile vehicle 2 may be a vehicle that can move autonomously, such as an autonomous mobile robot (AMR), an unmanned guided vehicle (AGV), or an unmanned aerial vehicle. The environmental field can be a closed space such as a warehouse, or an open space such as a city.

The autonomous mobile vehicle 2 includes a vehicle body 21, a first Lidar module 22 and a second Lidar module 23, wherein the first Lidar module 22 is fixed on the vehicle body 21, and the second Lidar module is selectively assembled on and disassembled from the vehicle body 21. In addition, the first Lidar module 22 is a low-resolution Lidar module, and the second Lidar module 23 is a high-resolution Lidar module. The second Lidar module 23 includes a bracket 231 and a high-resolution Lidar 232, wherein the bracket 231 is configured to support and electrically connect the high-resolution Lidar 232, connected to the vehicle body 21 with contact electrical contacts 233 to perform power and signal transmission, and fixed on vehicle body 21 through a magnet 234 by a magnetic attraction. It should be noted that the present invention does not limit the components included in the first Lidar module 22 and the second Lidar module 23, that is, the components included in the first Lidar module 22 may be the same or different from the second Lidar module 23. The components included in the first Lidar module 22 and the second Lidar module 23 are intended to be fixed and/or arranged and electrically connected to the vehicle body 21. Therefore, the present invention does not limit the manner in which the first Lidar module 22 and the second Lidar module 23 are fixed and/or arranged to the vehicle body 21, and also does not limit the manner in which the first Lidar module 22 and the second Lidar module 23 are electrically connected to the vehicle body 21 to perform power and signal transmission.

In addition, the Lidar module assembly and disassembly equipment 3 can be coupled to the at least one autonomous mobile vehicle 2, and configured to assemble the second Lidar module 23 on the vehicle body 21 of the autonomous mobile vehicle 2 or disassemble the second Lidar module 23 from the vehicle body 21 of the autonomous mobile vehicle 2. It should be noted that the mechanism of assembling the second Lidar module 23 on the vehicle body 21 of the autonomous mobile vehicle 2 or disassembling the second Lidar module 23 from the vehicle body 21 of the autonomous mobile vehicle 2 can cooperate with the mechanism and components of the second Lidar module 23. Its main purpose is for assembling and disassembling the second Lidar module 23, so the present invention does not limit the mechanism of the Lidar module assembly and disassembly equipment 3 for assembling and disassembling the second Lidar module 23.

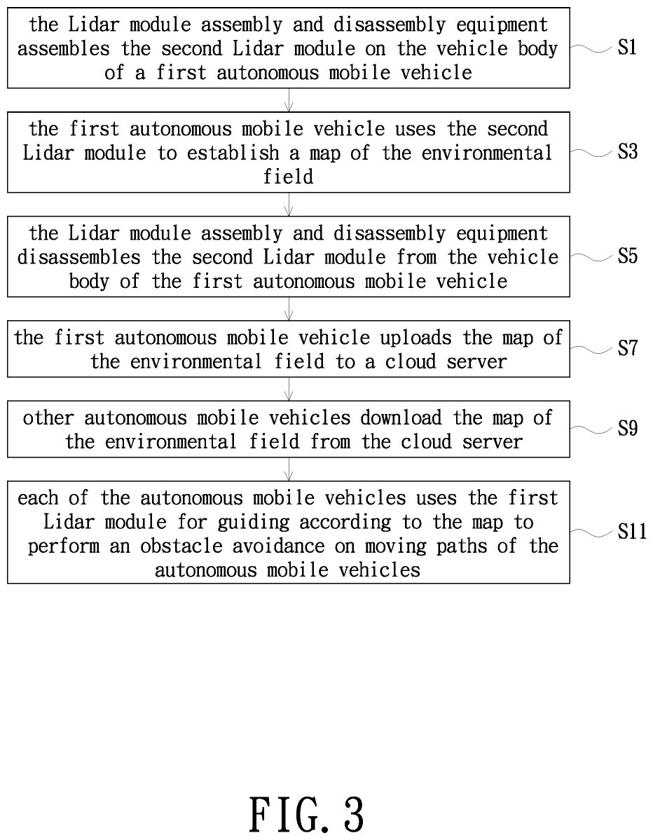

Please refer to FIG. 3, the flow diagram of a guidance and obstacle avoidance method for an environmental field is provided by an embodiment of the present invention. The guidance and obstacle avoidance method of the autonomous mobile vehicle 2 includes the following operations. In Step S1, the Lidar module assembly and disassembly equipment 3 assembles the second Lidar module 23 on the vehicle body 21 of a first autonomous mobile vehicle 2. In Step S3, the first autonomous mobile vehicle 2 uses the second Lidar module 23 to establish a map of the environmental field. In Step S5, the Lidar module assembly and disassembly equipment 3 disassembles the second Lidar module 23 from the vehicle body 21 of the first autonomous mobile vehicle 2. In Step S7, the first autonomous mobile vehicle 2 uploads the map of the environmental field to a cloud server. In Step S9, other autonomous mobile vehicles 2 download the map of the environmental field from the cloud server. In Step S11, each of the autonomous mobile vehicles 2 uses the first Lidar module 22 for guiding according to the map to perform an obstacle avoidance on moving paths of the autonomous mobile vehicles 2. In addition, it should be noted that the first autonomous mobile vehicle 2 uploading the map of the environmental field to the cloud server can be executed after the first autonomous mobile vehicle 2 using the second Lidar module 23 to establish a map of the environmental field or the Lidar module assembly and disassembly equipment 3 disassembling the second Lidar module 23 from the vehicle body 21 of the first autonomous mobile vehicle 2. Therefore, the present invention does not limit step S7 to occur after step S3 or step S5.

In summary, an autonomous mobile vehicle, and a guidance and obstacle avoidance method are provided by the present invention. When an autonomous mobile vehicle first arrives in the environmental field, the autonomous mobile vehicle dispatching station assembles a high-resolution Lidar on the autonomous mobile vehicle, so that the autonomous mobile vehicle can easily create a map of the environmental field through the high-resolution Lidar and upload the map of the environmental field to a cloud server, and other autonomous mobile vehicles can download the map of the environmental field from the cloud server. After establishing the map of the environmental field, the autonomous mobile vehicle dispatching station disassembles the high-resolution Lidar from the autonomous mobile vehicle, and all the autonomous mobile vehicles can operate according to the complete map in the future, and can be guided based on the complete map and avoid obstacles through the low-resolution Lidar fixed on the autonomous mobile vehicle. In this way, the cost of autonomous mobile vehicles can be reduced, and at the same time, problems such as abnormal map creation or failure of map creation due to insufficient Lidar resolution will not occur.

Although the present invention has been disclosed as above with the embodiments, it is not intended to limit the present invention. Those ordinarily skilled in the art may make some modifications and retouching without departing from the spirit and scope of the present invention. Therefore, the protection scope of the present invention shall be determined by the scope of the attached claims.

What is claimed is:

1. An autonomous mobile vehicle, applied to load and unload goods in an environmental field, comprising:
a vehicle body, configured to carry goods;
a first Lidar module, fixed on the vehicle body; and
a second Lidar module, selectively assembled on and disassembled from the vehicle body;
wherein when the second Lidar module is assembled on the vehicle body, the autonomous mobile vehicle uses the second Lidar module to establish a map of the environmental field;
wherein when the second Lidar module is disassembled from the vehicle body, the autonomous mobile vehicle is guided by using the first Lidar module according to the map to perform an obstacle avoidance on a moving path of the autonomous mobile vehicle.

2. The autonomous mobile vehicle as claimed in claim 1, wherein the first Lidar module is a low-resolution Lidar module, and the second Lidar module is a high-resolution Lidar module.

3. The autonomous mobile vehicle as claimed in claim 2, wherein the high-resolution Lidar module further includes a bracket for supporting and electrically connecting a high-resolution Lidar.

4. The autonomous mobile vehicle as claimed in claim 3, wherein the bracket is connected to the vehicle body with contact electrical contacts to perform power and signal transmission.

5. The autonomous mobile vehicle as claimed in claim 3, wherein the bracket is fixed on the vehicle body by a magnetic attraction.

6. The autonomous mobile vehicle as claimed in claim 1, wherein the autonomous mobile vehicle includes an autonomous mobile robot (AMR) and an automated guided vehicle (AGV).

7. A guidance and obstacle avoidance method for an environmental field, applied to a plurality of autonomous mobile vehicles, wherein each of the plurality of autonomous mobile vehicles includes a vehicle body and a first Lidar module fixed on the vehicle body, the guidance and obstacle avoidance method comprising:
assembling a second Lidar module on the vehicle body of a first autonomous mobile vehicle;
using the second Lidar module, by the first autonomous mobile vehicle, to establish a map of the environmental field;
disassembling the second Lidar module from the vehicle body of the first autonomous mobile vehicle;
uploading the map of the environmental field to a cloud server by the first autonomous mobile vehicle;
downloading the map of the environmental field from the cloud server by other autonomous mobile vehicles and
using the first Lidar module for guiding according to the map, by each of the plurality of autonomous mobile vehicles, to perform an obstacle avoidance on moving paths of the autonomous mobile vehicle.

8. The guidance and obstacle avoidance method as claimed in claim 7, wherein the first Lidar module is a low-resolution Lidar module, and the second Lidar module is a high-resolution Lidar module.

9. The guidance and obstacle avoidance method as claimed in claim 8, wherein the high-resolution Lidar module further includes a bracket for supporting and electrically connecting a high-resolution Lidar.

10. The guidance and obstacle avoidance method as claimed in claim 9, wherein the bracket is connected to the vehicle body with contact electrical contacts to perform power and signal transmission.

11. The guidance and obstacle avoidance method as claimed in claim 9, wherein the bracket is fixed on the vehicle body by a magnetic attraction.

12. The guidance and obstacle avoidance method as claimed in claim 7, wherein the autonomous mobile vehicle includes an autonomous mobile robot (AMR) and an automated guided vehicle (AGV).
